(19) United States
(12) Patent Application Publication
(10) Pub. No.: US 2004/0109673 A1
(43) Pub. Date: Jun. 10, 2004

(54) Recording and reproducing apparatus and method

(76) Inventors: Yusuke Yatabe, Yokohama (JP); Masaru Takahashi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/441,188

(22) Filed: May 20, 2003

(30) Foreign Application Priority Data
Dec. 9, 2002 (JP) 2002-356129

(51) Int. Cl. H04N 5/783

(52) U.S. Cl. 386/69; 386/70; 386/95

(57) ABSTRACT

A recording and reproducing apparatus and method are disclosed, which positively and easily realize the navigation for a desired image. At least a still picture for navigation is produced from an input moving picture, and a moving picture and the still picture are recorded in a recording media. At the time of navigation, the still pictures for navigation are collectively read and displayed in a list. A corresponding moving picture is read from the recording media based on the still picture selected by the user, and displayed in superposition on the still picture on a navigation screen. The simultaneous display of at least a still picture and a moving picture on the navigation screen realizes a positive navigation.

### BACKGROUND OF THE INVENTION

1. Field of the Invention

The present invention relates to a recording and reproducing apparatus and method for recording an image in a recording media and reproducing a desired image from the recording media by navigation.

2. Description of the Related Art

In recent years, it has become possible to record a plurality of or a long duration of moving picture data with a large file size using a digital video camera or the like having a recording media of a large capacity. In the case where a plurality of moving picture data are recorded over a long time, however, the user finds it difficult to search for the desired moving picture data at the time of reproduction.

A method of navigation in such a case is disclosed in JP-A-2001-111963, in which one frame of the leading image of the moving picture is accumulated in a memory at the time of starting to record each moving picture data, and a plurality of still picture thumbnails are produced from the leading images thus accumulated and displayed as a list on a display.

### SUMMARY OF THE INVENTION

In the method disclosed in JP-A-2001-111963, however, the desired image may not be identified simply with the still picture thumbnails for moving pictures which undergo great changes. Also, in the case where the leading images are very similar to each other, the desired image is difficult to search for simply with the leading scenes.

The object of the present invention is to provide a recording and reproducing apparatus and method for realizing the navigation to find the desired image without fail.

Other objects, features and advantages of the invention will become apparent from the following description of the embodiments of the invention taken in conjunction with the accompanying drawings.

### BRIEF DESCRIPTION OF THE DRAWINGS

These and other objects, features and advantages of the present invention will become more readily apparent from the following detailed description when taken in conjunction with the accompanying drawings, wherein:

FIG. 1 is a block diagram showing a recording and reproducing apparatus according to a first embodiment of the invention;

FIG. 2 is a diagram showing an example of the navigation screen according to the invention;

FIG. 3 is a diagram showing an example of the navigation screen according to the invention;

FIG. 4 is a diagram showing an example of the navigation screen according to the invention;

FIG. 5 is a block diagram showing a recording and reproducing apparatus according to a fifth embodiment of the invention;

FIG. 6 is a flowchart showing the operation of the recording and reproducing apparatus of FIG. 1;

FIG. 7 is a flowchart showing a recording and reproducing method according to a second embodiment of the invention;

FIG. 8 is a flowchart showing a recording and reproducing method according to a third embodiment of the invention;

FIG. 9 is a flowchart showing a recording and reproducing method according to a fourth embodiment of the invention;

FIG. 10 is a diagram showing an internal configuration of an AV codec in FIG. 1; and

FIG. 11 is a diagram showing a link configuration between still pictures in FIG. 8.

### DESCRIPTION OF THE EMBODIMENTS

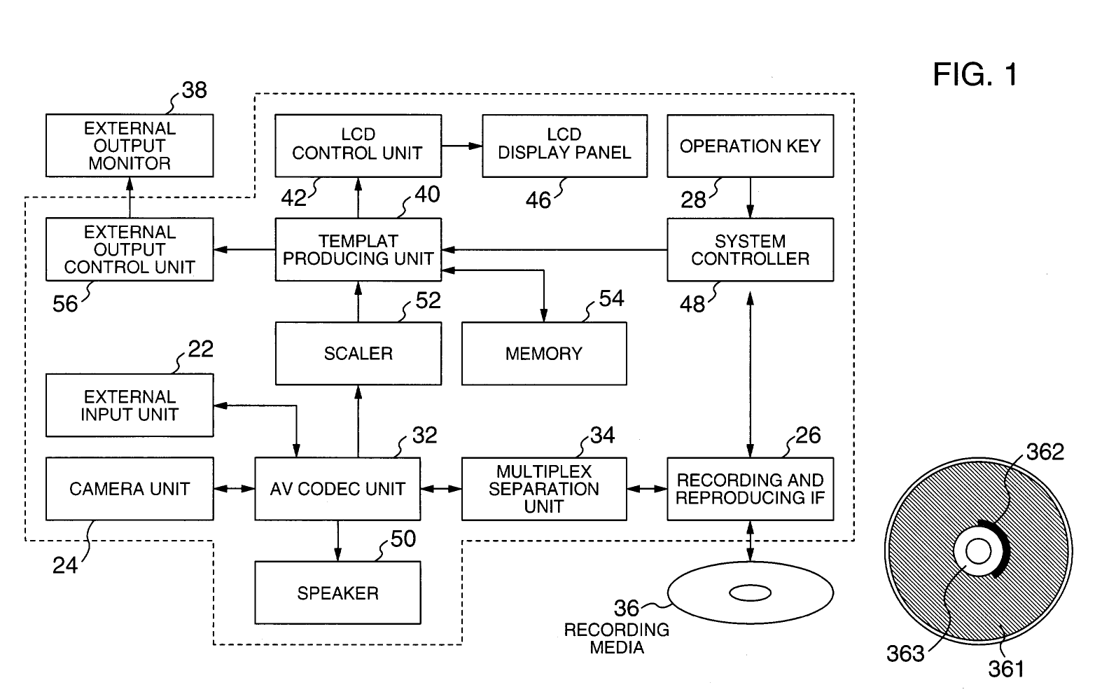

FIG. 1 is a block diagram showing a recording and reproducing apparatus according to a first embodiment of the invention. The configuration of each component part of this embodiment will be explained.

An AV codec 32 includes a buffer and a codec. At the time of recording, the digital quantized data or the like transferred from an external input unit or a camera unit 24 for inputting a picked-up image are stored in a buffer and code-converted to the MPEG format by the codec. Further, one frame of the leading image, for example, at the time of starting the recording is temporarily stored in a buffer together with the thumbnail data and used for producing a thumbnail of a still picture. At the time of reproduction, the MPEG data reproduced from a recording media 36 are accumulated in a buffer, expanded to the moving picture data by the codec and transferred to a scaler unit 52. The AV codec 32 can also expand the still picture thumbnail data reproduced from the recording media. Also, the camera unit 24 may be connected externally.

A multiplex separation unit 34 separates the voice data from the moving picture data.

A recording and reproducing interface 26 is such that the moving picture data, the still picture data, etc. sent from the AV codec 32 are recorded in the recording media 36 or reproduced from the media 36. In the case where the media 36 is an optical disk, the interface 26 includes an optical head or an image pick-up as a read/write unit.

The recording media 36 is accessible randomly and made up of, for example, an optical disk such as a DVD-RAM. A hard disk drive or a semiconductor memory may also be used. The recording media 36 has three areas including, for example, a moving picture data recording area 361 for recording the MPEG data, i.e. the compressed moving picture data compressed by the MPEG system, a still picture data recording area 362 for recording the still picture data, and a management information recording area 363 for recording the management information indicating an address or the like of the data on the recording media. Each moving picture data may correspond to one or a plurality of still picture data.

In the scaler unit 52, the moving picture data transferred from the AV codec 32 at the time of reproduction is scaled to the size of the moving picture thumbnail area 62 of a template image thereby to produce a moving picture thumbnail and transfer the thumbnail to a template producing unit 40.

The moving picture thumbnail is defined as the moving picture data to be displayed in the moving picture thumbnail display area 62, which data is scaled to the size of the moving picture thumbnail display area 62.

In a system controller 48, the still picture thumbnails reproduced from the recording media are expanded, scaled and transferred to the template producing unit 40. The expansion of the still picture thumbnails can alternatively be carried out in the AV codec 32.

The still picture thumbnail is defined as an image produced by reducing the still picture data produced using the image at a predetermined position of the moving picture data, and holds at least a video ID, still picture thumbnail information and related information. Also, the still picture data is defined as a data produced using the image at a predetermined position of the moving picture data, and for example, includes the data recorded in the JPEG format in the recording media 36. The video ID indicates a moving picture data associated with a given thumbnail and includes the ID number of the still picture thumbnail and the storage address of a corresponding MPEG data. The related information includes the imaging date and time, etc.

The template producing unit 40 produces a template image for navigation using the still picture thumbnail transferred from the system controller 48, and holds the template image in a memory 54. Further, the moving picture thumbnail transferred from the scaler unit 52 is superposed on the template image thereby to produce a navigation screen, which is sent to and displayed on the display unit.

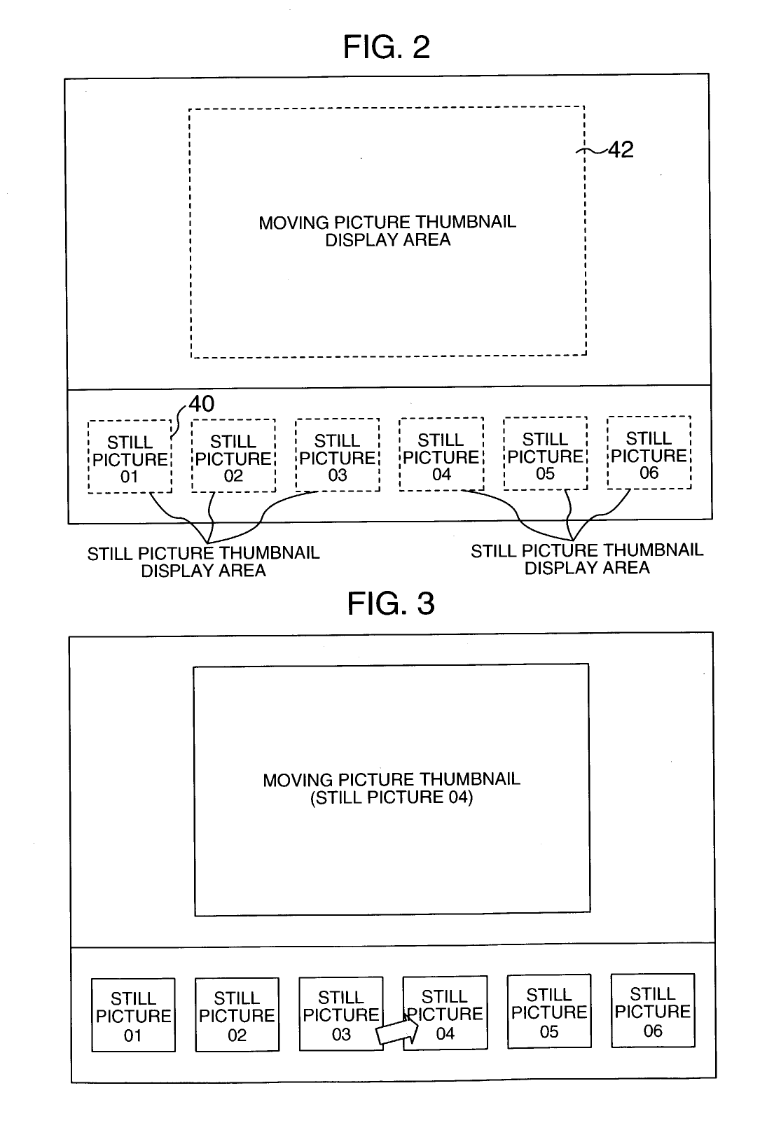

FIG. 2 shows an example of a template image. The navigation screen is configured of a plurality of still picture thumbnail display areas 40 and a single moving picture thumbnail display area 42.

In a LCD control unit 42 or an external output control unit 56, the signal produced in the template producing unit 40 is converted into a NTSC signal, for example, suitable for LCD output or external output and sent out to a LCD display panel 46 or an external output monitor 38.

The system controller 48 controls the recording and reproducing interface 26 and the template producing unit 40 in accordance with the contents of an instruction input from an operation key 28. Specifically, the recording and reproducing interface 26 is controlled in such a manner that the moving picture data corresponding to a selected still picture thumbnail is reproduced from the recording media, and the moving picture data thus reproduced is displayed on the navigation screen.

The operation key 28 is a user interface for transmitting the desire of the user to the system for selecting the navigation screen or selecting the desired image from the template images on the navigation screen. This user interface may be of either a touch pen input type or a button input type.

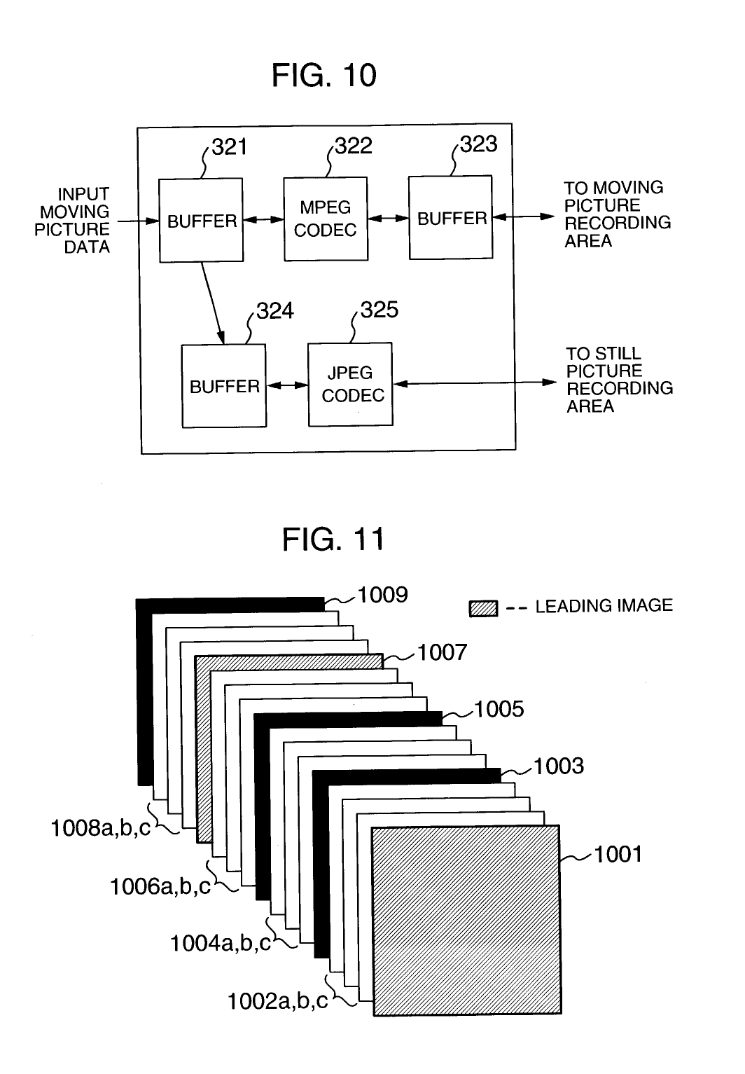

FIG. 10 is a diagram showing an internal configuration of the AV codec 32 shown in FIG. 1. The moving picture data imaged or input by a camera unit 24 or an external input unit 22 are accumulated in a buffer 321. The moving picture data are compressed in a MPEG codec 322 by the MPEG method and accumulated in a buffer 323 in order to increase the rate at which the MPEG data having a great amount of information are written into a recording media. On the other hand, the leading image of the moving picture data accumulated in the buffer 321 is accumulated together with the video ID and the related information in a buffer 324 and compressed in a JPEG codec 325 by the JPEG method thereby to produce a compressed still picture data. The timing of producing the still picture data is not necessarily corresponding to the leading image but an image associated with a scene change or a given one of images at a predetermined time interval. Also, the video ID and the related information may be added at the time of recording in the recording media 36.

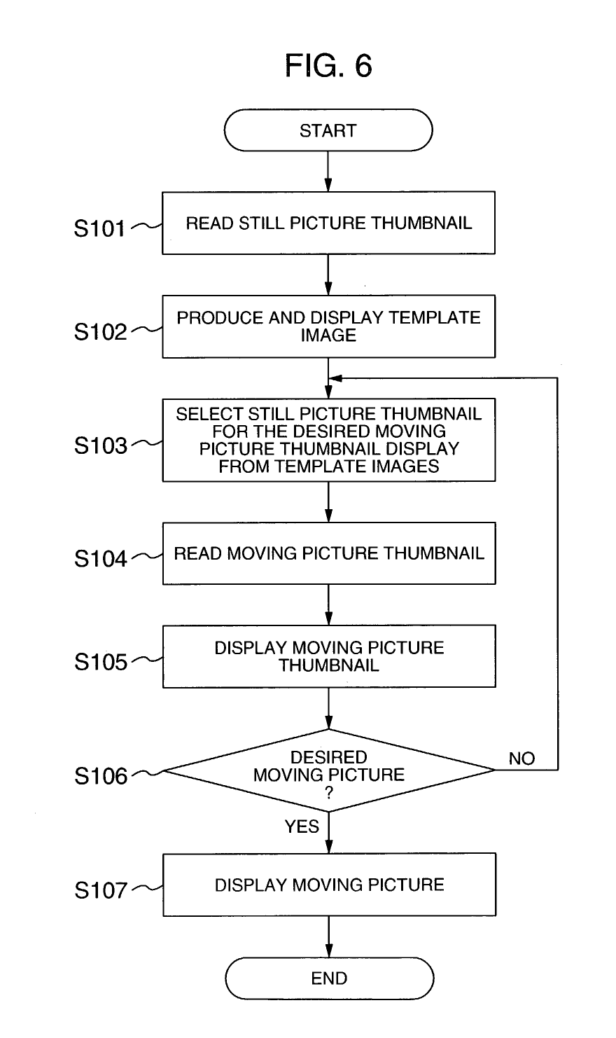

FIG. 6 is a flowchart showing the operation of the recording and reproducing apparatus of FIG. 1.

Upon selection of a navigation mode through the operation key 28 by the user, the navigation mode selection is notified to the system controller 48. The system controller 48 accesses the management information in the management information recording area 363 of the recording media 36 through the recording and reproducing interface 26, and reads the still picture data from the still picture data recording area 362 based on the management information in the order of, for example, the imaging date/time information (step 101). The still picture data thus read are transferred to the system controller 48. After that, the still picture data are transferred to the template producing unit 40, and a template image composed of a still picture thumbnail is produced (step 102) and accumulated in a memory 54. The still picture data thus accumulated are then transferred to and displayed on the external output control unit 56 or the LCD control unit 42. The still picture thumbnails may be arranged not necessarily in the order of the imaging date/time but, for example, in the descending order of the file size.

Next, the desired still picture thumbnail is selected from the template images by the user (step 103). FIG. 3 shows an example of the select process executed by setting the cursor or the pointer (hereinafter collectively referred to as the cursor). The video ID of the still picture thumbnail on the template image is notified to the system controller 48. The system controller 48 reads the MPEG data corresponding to the video ID from the moving picture data recording area 361 of the recording media 36 through the recording and reproducing interface 26 (step 104), and transfers the particular data to the multiplex separating unit 34. The multiplex separating unit 34 separates the voice data from the MPEG data transferred thereto. The MPEG data are expanded to the moving picture data by the AV codec 32 and transferred to the scaler unit 52.

The scaler unit 52 scales the moving picture data into a moving picture thumbnail by scaling it into a form suitable for the moving picture thumbnail display area 62 shown in FIG. 2. In the template producing unit 40, the moving picture thumbnail scaled is superposed on the template image composed of the still picture thumbnail stored in the memory 54 thereby to output a moving picture thumbnail (step 105). In the case where the reproduction of the voice of the moving picture data is desired, on the other hand, the voice data separated by the multiplex separating unit 34 is expanded by the AV codec 32 and reproduced from a speaker unit 50 in synchronism with the reproduction of the moving picture data.

In the case where the moving picture thumbnail displayed in the area 62 represents the moving picture data desired by the user, the particular moving picture data is reproduced and displayed on the display unit (step 107). In the case where the moving picture thumbnail displayed in the area 62 is associated with the moving picture data not desired by the user, on the other hand, another still picture thumbnail is selected and the navigation is repeated (step 106).

According to this embodiment, the template image with a still picture thumbnail is attached thereon is stored in a memory, and the moving picture thumbnail read and produced from the recording media is displayed in superposition on the template image. In this way, the image navigation using both the still picture and the moving picture can be realized. Also, in view of the fact that the still picture data corresponding to a still picture thumbnail is recorded in an exclusive area 362 of the recording media, the production of a still picture thumbnail is facilitated and the image navigation can be carried out immediately.

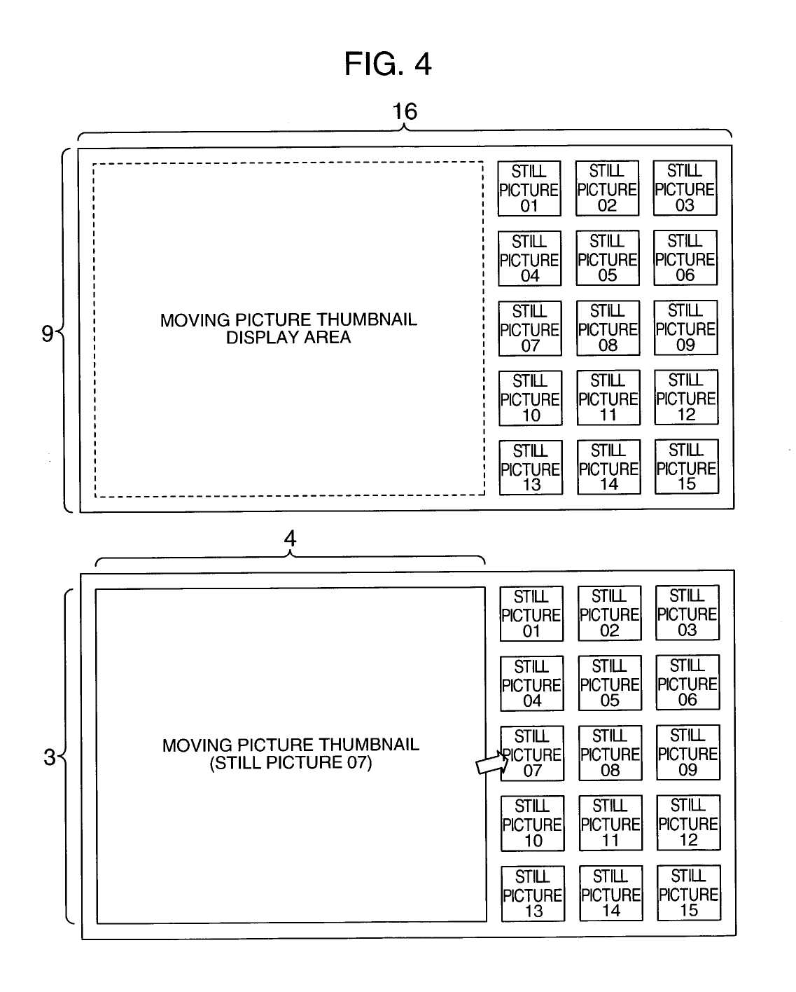

FIG. 4 shows another example display of a navigation screen of a recording and reproducing apparatus according to the invention. In recent years, the Hi-Vision broadcasting has employed a display unit of a screen size having an aspect ratio of 16:9. In the case where the moving picture thumbnail of the conventional image size having an aspect ratio of 4:3 is displayed on this display unit, i.e. in the case where the aspect ratio of the video data is different from that of the display screen, then the display as shown in FIG. 4 also possible by use of the scaler unit 52. In this example, the video data is displayed to the full vertical size of the display screen to secure the correct aspect ratio of the whole video data. In the process, the still picture thumbnail is displayed in an area other than the moving picture thumbnail display area 62. As a result, the moving picture thumbnail image can be displayed effectively even in the case where the aspect ratio of the MPEG data recorded is different from the display screen size.

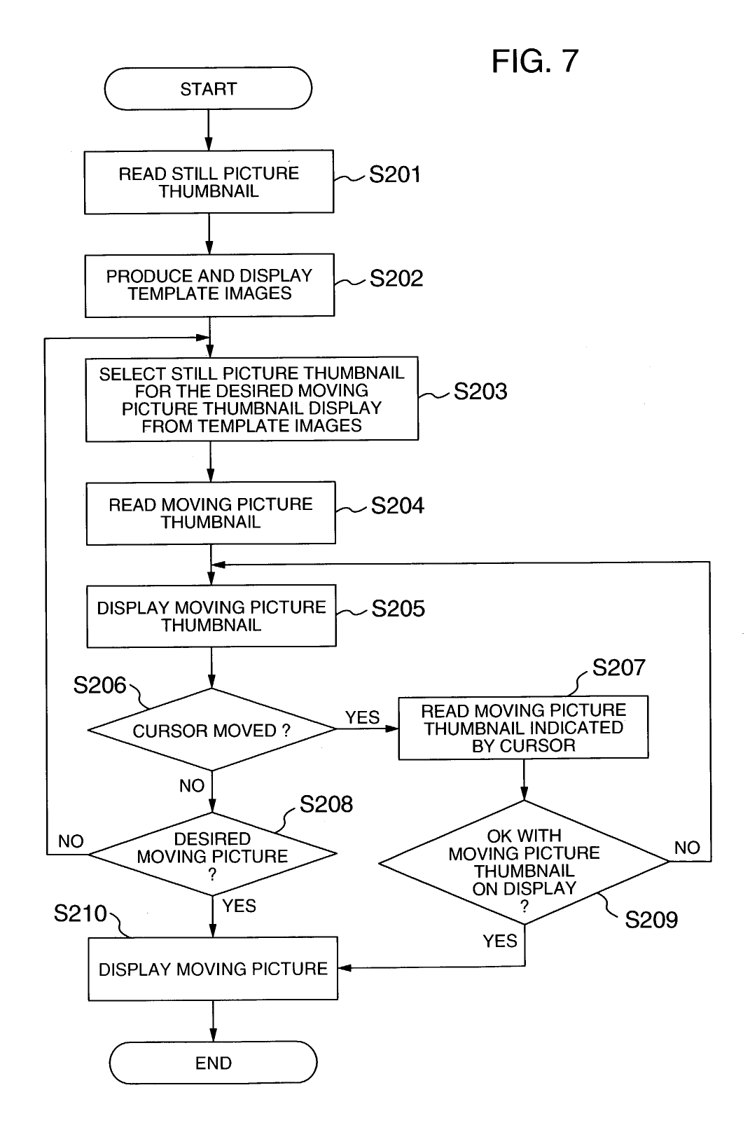

FIG. 7 is a flowchart of a recording and reproducing method according to a second embodiment of the invention. In the moving picture thumbnail display area 62, the moving pictures are smoothly changed in accordance with the selection change of the still picture thumbnail. The process of steps 201 to 204 is similar to the process of steps 101 to 104 in FIG. 6.

In the case where a moving picture thumbnail selected is reproduced in the moving picture thumbnail display area 62 in navigation mode (step 205), the user moves the cursor and selects the still picture thumbnail desired for next display (step 206). In the system controller, the moving picture data corresponding to the video ID of the still picture thumbnail indicated by the cursor is read concurrently from the recording media (step 207), and stored, for example, in the memory 54. As a result, the moving picture thumbnail next to be displayed can be displayed instantaneously without interruption on the display unit. Quantitatively, the use of the DVD-RAM as a recording media 36 can reduce the time of about one second for the normal operation of reading the moving picture data to about 0.1 second.

In the case where a still picture thumbnail is selected by touch pen or the like, on the other hand, the cursor may be absent. In such a case, the head portion of the moving picture data indicated by the video ID of every still picture thumbnail displayed on the display unit is accumulated in advance in the memory unit 54. In this way, the instantaneous reproduction can be realized.

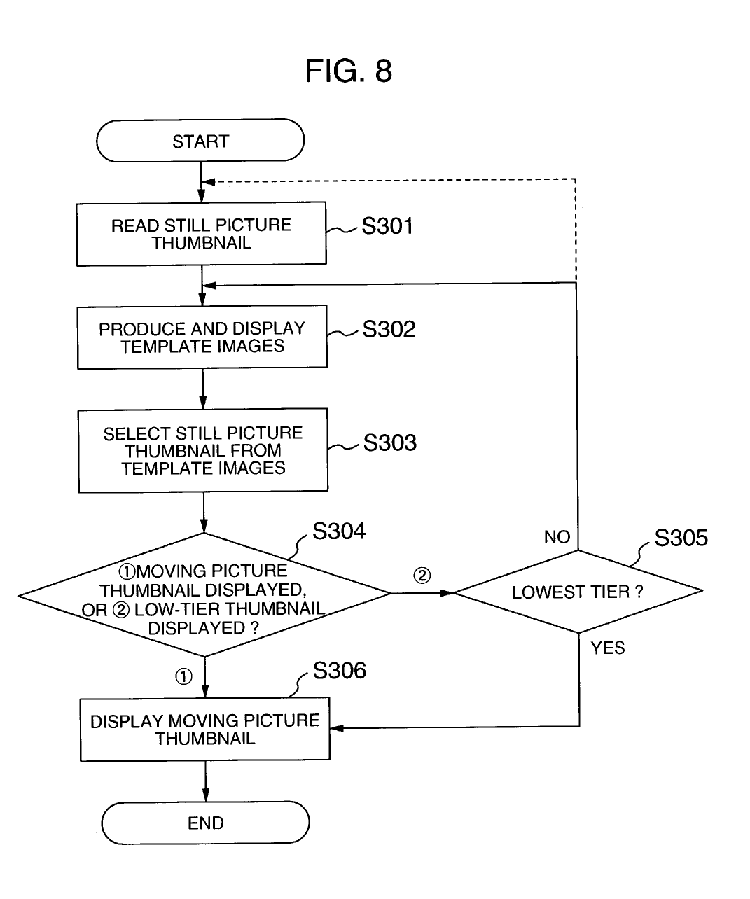

FIGS. 8 and 11 are a flowchart and a diagram, respectively, for explaining a recording and reproducing method according to a third embodiment of the invention. According to this embodiment, the navigation is carried out hierarchically. The still picture thumbnail thus holds a link or pass (hereinafter referred to as the link information) to the still picture thumbnail of one lower tier of the hierarchy related to a particular still picture thumbnail, in addition to the video ID, the thumbnail data and the related information. Naturally, the still picture thumbnail in the lowest tier of the hierarchy has no link information to a lower tier.

FIG. 11 shows an example of the link configuration between still pictures. The still pictures 1001, 1007 of the leading image of each moving picture data represent the first tier of the hierarchy, and the still pictures 1001, 1007 of the leading image and the still pictures 1003, 1005, 1009 between the still pictures 1001 and 1007 represent the second tier of the hierarchy. The link to the still pictures 1003, 1005, together with the related information, is held in the still picture 1001, and the link to the still picture 1009, together with the related information, is held in the still picture 1007, at the time of producing a still picture during the image pick-up operation. Further, the still picture 1003 may have still pictures 1004a, 1004b, 1004c and the information on the third tier of the hierarchy. As a specific example, the user's selection of a still picture thumbnail corresponding to the still picture 1001 leads to a procedure in which the moving picture thumbnail corresponding to the particular still picture 1001 is displayed in the moving picture thumbnail area and the still picture thumbnails corresponding to the still pictures 1001, 1003, 1005 are displayed in the still picture thumbnail area. Other link systems may be used as far as the address, etc. of each still picture can be discriminated.

The operation of this embodiment will be explained with reference to FIG. 8. As described above, a template image is produced based on the still picture thumbnail in the highest tier of the hierarchy of the still picture thumbnails accumulated in the memory (step 302) and displayed on the display unit.

Next, in the case where the user sets the cursor or pointer (hereinafter referred to as the cursor) to and determines the desired still picture thumbnail from the template images (step 303), the still picture thumbnail in the second tier of the hierarchy is displayed (step 304) through the link information from the still picture thumbnail on the template image. This operation is repeated down to the lowest tier of the hierarchy (step 305).

The memory unit 54 may hold either the still picture thumbnails of all the tiers of the hierarchy, only the tier of the hierarchy of the still picture thumbnail on display, or the tier of the hierarchy of the still picture thumbnail on display and an immediately lower tier of the hierarchy. Further, the moving picture thumbnail corresponding to the selected still picture thumbnail may be displayed in the display area 62 while at the same time displaying the still picture thumbnail of a lower tier of the hierarchy in the display area 60.

Furthermore, with regard to a given tier of the hierarchy, the moving picture thumbnail or the still picture thumbnail existing in a lower tier (no such thumbnail for the lowest tier) of the hierarchy may be selectively displayed (step 304).

According to this embodiment, the desired image can be obtained efficiently by utilizing the link information between still picture thumbnails.

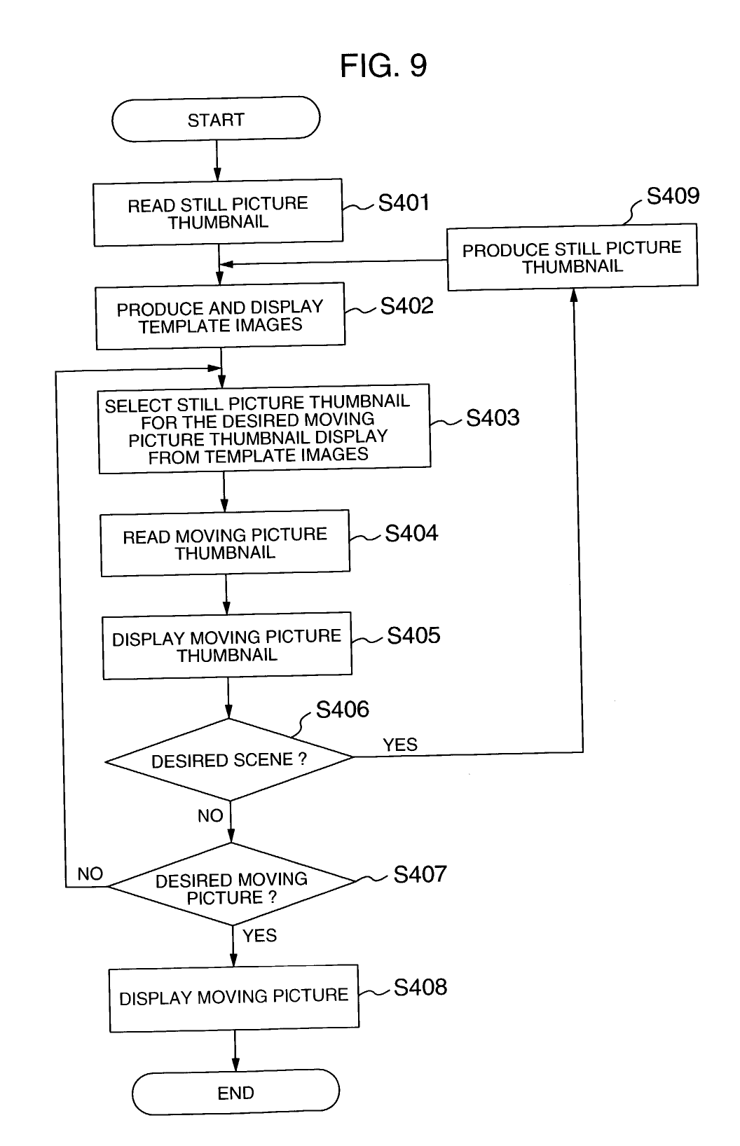

FIG. 9 is a flowchart of a recording and reproducing method according to a fourth embodiment of the invention. While a moving picture thumbnail is reproduced in the moving picture thumbnail display area 62, the user produces a still picture thumbnail by pulling out the desired scene freely from the moving picture thumbnail.

In the case where the moving picture thumbnail is reproduced on the template image (step 405), assume that a scene appears which is desired by the user to add to the representative screen or replace with the existing still picture thumbnail (step 406). The fact is notified to the system controller 48 by the operation key 28. The system controller 48, controlling the AV codec 32, pulls out the frame image from the moving picture data accumulated in the buffer 321 in the AV codec 32, scales it to the size of the still picture thumbnail area and thus accumulates the frame image as a still picture thumbnail in the memory 54 (step 407). The still picture thumbnails accumulated in the memory 54 are displayed on the display unit (step 402).

At this time point, the still picture thumbnail is accumulated only in the memory 54 and not yet recorded in the recording media. In the case where the user is desirous of recording it in the recording media, therefore, the particular still picture thumbnail can be replaced with a recorded or existing still picture thumbnail. For example, the frame image of the moving picture data accumulated in the buffer 321 of the AV codec 32 is transferred as it is to the buffer 324, and by being compressed by a JPEG codec, recorded in the recording media 36.

According to this embodiment, the user can display the desired scene as a representative scene, and therefore the subsequent navigation work is facilitated more conveniently.

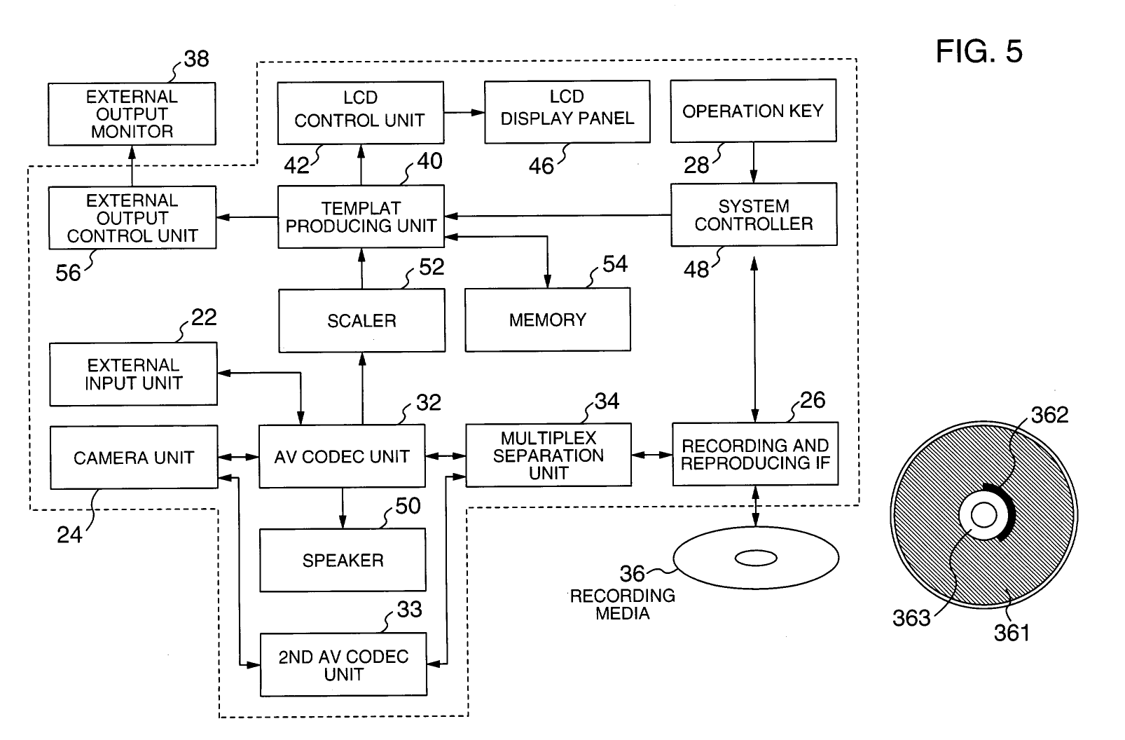

FIG. 5 is a block diagram showing a recording and reproducing apparatus according to a fifth embodiment of the invention. This embodiment is different from the first embodiment in that a low-rate moving picture recording area 364 is arranged on the recording media. The low-rate moving picture recording area 364 may have recorded therein a low-resolution moving picture such as MPEG4 defined in ISO/IEC 14496 as a moving picture thumbnail or only the P picture of the moving picture as a moving picture thumbnail. A low-rate moving picture may be produced either during or after the recording operation. In the former case, as shown in FIG. 5, a second AV codec 33 is added.

According to this embodiment, the recording operation is performed with a downgraded image quality of the moving picture, and therefore the data capacity is reduced, thereby making it possible to shorten the time length before display of the moving picture thumbnail.

As another method, the navigation may be carried out with the voice data alone. This method can reduce the power consumption by the load of the processing for image expansion or image scaling. Further, the navigation with the voice alone or the the navigation using both the image and the voice may be selected. As a result, the power consumption mode or the high-accuracy navigation mode, for example, can be selected by the user for an increased convenience.

The invention may be embodied in other specific forms without departing from the spirit or essential characteristics thereof. The embodiments are therefore to be considered in all respects as illustrative and not restrictive, the scope of the invention being indicated by the appended claims rather than by the foregoing description and range of equivalency of the claims are therefore intended to be embraced therein.

What is claimed is:

1. A recording and reproducing apparatus comprising:
a compressor, which produces still picture data for navigation from inputted moving picture data and compressing, the moving picture data and the still picture data;
a recorder and reproducer, which records the moving picture data and the still picture data compressed by the compressor in a moving picture recording area and a still picture recording area, respectively, on a recording media, and reproducing the compressed moving picture data and the compressed still picture data from the recording media;
An expander, which expands, the compressed moving picture data and the compressed still picture data reproduced by the recorder and reproducer;
a screen producing unit which produces at least a moving picture thumbnail and at least a still picture thumbnail using the moving picture data and the still picture data, respectively, expanded by the expander, and producing a navigation screen assigned to a moving picture thumbnail display area and a still picture thumbnail display area, respectively, in the screen;
a display which displays the navigation screen produced by the screen producing unit; and
a controller which causes, upon selection of a still picture thumbnail displayed on the navigation screen, the recorder and reproducer to reproduce the moving picture data corresponding to the still picture thumbnail from the recording media, and the screen producing unit to produce the moving picture thumbnail and assign the moving picture thumbnail to the moving picture thumbnail display area.

2. A recording and reproducing apparatus comprising:
a compressor including a still picture data producing unit for producing still picture data for navigation from inputted moving picture data and a compression unit for compressing the moving picture data and the still picture data;
a recorder and reproducer which records the moving picture data and the still picture data compressed by the compressor in a moving picture recording area and a still picture recording area, respectively, on a recording media, and reproducing the compressed moving picture data and the compressed still picture data from the recording media;
an expander, which expands, the compressed moving picture data and the compressed still picture data reproduced by the recorder and reproducer;
a screen producing unit including a first scaler unit which produces at least a still picture thumbnail by scaling the still picture data expanded by the expander to a size of a still picture thumbnail display area, a navigation screen producing unit which produces a navigation screen using the still picture thumbnail, a memory which stores the navigation screen, and a second scaler unit which produces at least a moving picture thumbnail by scaling the moving picture data expanded by the expander to a size of a moving picture thumbnail display area, the navigation screen producing unit also producing the moving picture thumbnail on the navigation screen stored in the memory;
a display which displays the navigation screen produced by the screen producing means; and
a controller which causes, upon selection of a still picture thumbnail displayed on the navigation screen, the recorder and reproducer to reproduce the moving picture data corresponding to the still picture thumbnail from the recording media, and the screen producing unit to produce the moving picture thumbnail and assign the moving picture thumbnail to the moving picture thumbnail display area.

3. A recording and reproducing apparatus according to claim 1,
wherein the controller causes the recorder and reproducer to reproduce a moving picture predicted for next display and the screen producing unit to produce a moving picture thumbnail and stores the moving picture thumbnail in a memory during a time when a moving picture thumbnail corresponding to the still picture thumbnail is displayed on the display.

4. A recording and reproducing apparatus according to claim 2,
wherein the controller causes the recorder and reproducer to reproduce a moving picture data predicted for next display and the screen producing unit to produce a moving picture thumbnail and store the moving picture thumbnail in a memory during a time when a moving picture thumbnail corresponding to the still picture thumbnail is displayed on the display.

5. A recording and reproducing apparatus according to claim 1,
wherein the compressor adds link information indicating a relation with other still picture data when the still picture data is produced; and
wherein in response to a user selecting one of the still picture thumbnails, the controller reproduces a still picture data related to the still picture thumbnail from the recording media and displays the still picture data in the still picture thumbnail display area based on the link information.

6. A recording and reproducing apparatus according to claim 2,
wherein the compressor adds link information indicating a relation with other still picture data when the still picture data is produced; and
wherein in response to a user selecting one of the still picture thumbnails, the controller reproduces the still picture data related to the still picture thumbnail from the recording media and displays the still picture data in the still picture thumbnail display area based on the link information.

7. A recording and reproducing apparatus according to claim 1,
wherein upon selection of a given screen of the moving picture thumbnail on display in the case where the still picture thumbnail and the moving picture thumbnail selected by the user are displayed on the display, the controller causes the expander/compressor and the screen producing unit to produce a new still picture thumbnail from the selected screen and add the new still picture thumbnail to the still picture display area or replace the still picture thumbnail on display with the new still picture thumbnail.

8. A recording and reproducing apparatus according to claim 2,
wherein upon selection of a given screen of the moving picture thumbnail on display in the case where the still picture thumbnail and the moving picture thumbnail selected by a user are displayed on the display, the controller causes the compressor/expander and the screen producing unit to produce a new still picture thumbnail from the selected screen and add the new still picture thumbnail to the still picture display area or replace the still picture thumbnail on display with the new still picture thumbnail.

9. A recording and reproducing apparatus according to claim 1,
wherein the still picture thumbnail holds an ID number of the compressed moving picture data and a thumbnail ID number including a storage address.

10. A recording and reproducing method comprising steps of:
producing still picture data for navigation using a inputted moving picture data, compressing the moving picture data, recording the compressed moving picture data in a moving picture recording area on a recording media, compressing the still picture data, and recording the compressed still picture data in a still picture recording area on a recording media;
reproducing the compressed still picture data from the recording media, expanding the compressed still picture data, producing a still picture thumbnail and displaying the still picture thumbnail in a still picture thumbnail display area of the navigation screen; and
upon selection of the still picture thumbnail displayed in the still picture thumbnail display area, reproducing the compressed moving picture data related to the still picture thumbnail from the recording media, expanding the moving picture data, producing a moving picture thumbnail, and displaying the moving picture thumbnail together with the still picture thumbnail in a moving picture thumbnail display area of the navigation screen;
wherein the still picture thumbnail display area and the moving picture thumbnail display area represent different areas on the same navigation screen, and the still picture recording area and the moving picture recording area represent different areas on the recording media.

11. A recording and reproducing method according to claim 10,
further comprising the step of reproducing a moving picture data predicted for next display, producing a moving picture thumbnail and holding the moving picture thumbnail in a memory, in the case where the moving picture thumbnail is displayed together with the still picture thumbnail.

12. A recording and reproducing method according to claim 10,
wherein, upon selection of a still picture thumbnail displayed in the still picture thumbnail display area, other still picture data related to the still picture thumbnail is read from the still picture recording area and expanded thereby to produce and display a still picture thumbnail in the still picture thumbnail display area of the navigation screen.

13. A recording and reproducing method according to claim 10,
wherein, upon selection of a given screen of a moving picture thumbnail on display in the case where the moving picture thumbnail and the still picture thumbnail are on display at the same time, a new still picture thumbnail is produced from the selected screen and added to the still picture thumbnail display area or replaced with the still picture thumbnail on display.

14. A recording and reproducing method according to claim 10,
wherein the recording media is an optical disk.

15. A recording and reproducing apparatus according to claim 1,
wherein the recording media is an optical disk.

16. A recording and reproducing apparatus according to claim 1,
further comprising imaging unit which images a moving picture.

17. A recording and reproducing apparatus according to claim 2,
wherein the compressor includes a production unit which produces still picture data from the inputted moving picture data, a first compression unit which compresses the moving picture data and a second compression unit which compresses the still picture data.
